(19) United States
(12) Patent Application Publication
(10) Pub. No.: US 2025/0092219 A1
(43) Pub. Date: Mar. 20, 2025

(54) POLYPROPYLENE COMPOSITION RESISTANT TO THERMO-OXIDATIVE AGING, PREPARATION METHOD AND USE THEREOF

(71) Applicant: KINGFA SCI. & TECH. CO., LTD., Guangzhou, Guangdong (CN)

(72) Inventors: Bo Yang, Guangzhou, Guangdong (CN); Pingxu Chen, Guangzhou, Guangdong (CN); Nanbiao Ye, Guangzhou, Guangdong (CN); Zhongfu Luo, Guangzhou, Guangdong (CN); Juanxia Su, Guangzhou, Guangdong (CN); Zhaoliang Lu, Guangzhou, Guangdong (CN)

(21) Appl. No.: 18/729,571

(22) PCT Filed: Dec. 28, 2022
(86) PCT No.: PCT/CN2022/142741

§ 371 Date: Jul. 17, 2024

(30) Foreign Application Priority Data
Jan. 19, 2022 (CN) 202210062608.1

(51) Int. Cl. C08K 3/04; C08J 3/20; C08K 3/26; C08K 3/34; C08L 23/12

(52) U.S. Cl. CPC C08K 3/04; C08J 3/203; C08K 3/26; C08K 3/346; C08L 23/12; C08J 2323/12; C08J 2400/26; C08J 2409/08; C08K 2003/265; C08K 2201/006; C08L 2201/08

(57) ABSTRACT

The present disclosure relates to a polypropylene composition resistant to thermo-oxidative aging, a preparation method and a use thereof. The polypropylene composition resistant to thermo-oxidative aging comprises polypropylene, a toughener, a filler, carbon black and other additive or additives. The polypropylene composition resistant to thermo-oxidative aging provided in the present disclosure has a better thermo-oxidative aging resistance by adding specific carbon black, without any complicated surface modification for the carbon black, and the polypropylene composition can be widely used in auto parts or cables.

### TECHNICAL FIELD

The present disclosure belongs to the technical field of engineering plastics, and specifically relates to a polypropylene composition resistant to thermo-oxidative aging, a preparation method and a use thereof.

### BACKGROUND

Tertiary carbon atoms in the polypropylene chain are unstable and easy to form tertiary carbon free radicals in the presence of heat, light or oxygen. As the tertiary carbon free radicals are very active and cause the chain breaking and the degradation of polypropylene molecular chains, the polypropylene molecular chains are easy to enter a spontaneous oxidation cycling process under the action of oxygen, which eventually leads to the aging of polypropylene materials. The common solution is to delay or inhibit the aging process by adding antioxidants to capture the generated free radicals, thereby extending the storage life and service life of polypropylene and products thereof. As a most common plastic colorant, carbon black is an inorganic pigment and has a good photostability. During outdoor use, the plastic parts produced with carbon black can also be used as a light shielding agent to absorb ultraviolet light and extend the service life of the material. Therefore, carbon black is widely used in colored products of polypropylene. However, the addition of carbon black often causes a serious degradation of the thermo-oxidative aging resistance of the polypropylene materials.

In prior art, the thermo-oxidative aging resistance of polypropylene is generally improved by adding a large amount of high efficient antioxidants and anti-thermo-oxidative aging additives. For example, the patent entitled “POLYPROPYLENE COMPOSITION HIGHLY RESISTANT TO HEAT AND WEATHER, AND PREPARATION METHOD THEREOF” discloses that epoxy resins are added to a similar carbon black colored product to make the surface layer of the polypropylene composition carbonized rapidly in a high temperature environment, so as to form a layer of “protective shield”, which reduces the penetration of oxygen in polypropylene materials and improves the thermo-oxidative aging resistance of polypropylene materials. In addition, a variety of antioxidants and stabilizers are combined to improve the long-term thermo-oxidative aging resistance of polypropylene materials, for example, by free radical capture, peroxide decomposition, oxygen barrier, etc., However, the addition of epoxy resin can easily cause appearance defects (pitting) and affect the mechanical properties of the materials.

In addition, some patents have concerned about the effects of carbon black on the thermo-oxidative aging property of materials. For example, the patent entitled “POLYPROPYLENE COMPOSITE MATERIAL AND PREPARATION METHOD THEREOF′ discloses that a surface modifier is used to treat carbon black, which effectively controls the adsorption of the surfaces of carbon black to the polypropylene polymer chains, and reduces the interfacial stress between carbon black and polypropylene. Meanwhile, the surface-treated carbon black has better dispersion, which not only can prevent the large-sized aggregates from occurring in the system and generating interfacial stresses, but also can reduce the effective contact between carbon black and antioxidants in the formula system. Thus, the oxidation effect of the surface-treated carbon black on antioxidants is reduced, which effectively reduce the negative impact of carbon black on the thermo-oxidative aging resistance of polypropylene composite materials. At the same time, the amount of antioxidants in the products is reduced, so are the costs and the risk of antioxidant release. However, the surface treatment process is complicated, and the introduced surface modifier is also the source of odors, volatile organic compounds (VOC), etc. from the subsequent materials.

Therefore, it is of important research significance and application value to develop a new polypropylene product which is colored with carbon black and has thermo-oxidative aging resistance.

### SUMMARY OF THE INVENTION

One object of the present disclosure is to overcome the defect or deficiency of the carbon black colored polypropylene product in the prior art and to provide a polypropylene composition resistant to thermo-oxidative aging. The polypropylene composition resistant to thermo-oxidative aging provided by the present disclosure can effectively improve the thermo-oxidative aging resistance by adding carbon black with a certain specific surface area, a certain oil absorption number and a certain molar percentage of oxygen, without any complicated surface modification for carbon black.

Another object of the present disclosure is to provide a preparation method of the polypropylene composition resistant to thermo-oxidative aging.

Another object of the present disclosure is to provide a use of the polypropylene composition resistant to thermo-oxidative aging in manufacturing automobile parts or cables.

To realize the above objects of the present disclosure, the following technical solution is adopted in the present disclosure.

A polypropylene composition resistant to thermo-oxidative aging, comprising the following components by weight:

| | | |
|---|---|---|
| polypropylene | 40-98 | parts, |
| a toughener | 0-25 | parts, |
| a filler | 0-30 | parts, |
| carbon black | 0.2-2.0 | parts, |
| an antioxidant | 0.3-0.6 | parts, |
| other additive or additives | 0-0.5 | parts, |

wherein the carbon black has a specific surface area of 38-113 m²/g, an oil absorption number of 55-165 ml/100 g, and a molar percentage of oxygen on a surface of the carbon black of 1.70-3.82%.

The specific surface area of carbon black is determined by the following process: In accordance with ASTM D6556-2016, the nitrogen adsorption method is adopted for testing, the specific surface area of carbon black is calculated based on the Brunauer-Emmett-Teller (BET) multilayer adsorption theory, and the test results represent the specific surface area of the carbon black.

The oil absorption number of carbon black is determined by the following process: In accordance with ASTM D2414-2017, the minimum amount of dibutyl phthalate required for filling all the voids of chain branches or fiber structures of the carbon black and wetting the surfaces of the carbon black is tested, and this minimum amount is also known as the DBP oil absorption number.

The molar percentage of oxygen on the surface of the carbon black is determined by an X-ray photoelectron spectroscopy (XPS) with a monochromatized AlKα source (1486.6 eV), a test current and voltage of 5 mA×15 kV, and the data are calibrated with the binding energy of C1s (284.80e V) as a standard.

It is found in researches that carbon black mainly plays a negative role in thermal aging process of polypropylene materials. The reason is that the carbon black, especially the high-chroma carbon black, has a large specific surface area and has a strong adsorption effect on antioxidant. As a result, during the thermal aging process of the materials, the antioxidant has a weaker migration ability to the surface and thus a lower surface concentration, which weakens the ability of the materials to resist thermo-oxidative aging. Therefore, the specific surface area and oil absorption number of carbon black will affect the thermo-oxidative aging resistance of black-colored polypropylene materials. A research (Patent CN109627601A) shows that the thermo-oxidative aging resistance of the black polypropylene composition can be improved to a certain extent by selecting carbon black with a certain specific surface area and a certain oil absorption number. However, it is still necessary to carry out a specific surface treatment on carbon black to improve the dispersion thereof, which not only prevents the large size aggregates from occurring in the system and generating interfacial stresses, but also reduces the effective contact between the carbon black and the antioxidant in the formula system, thereby reducing the oxidation effect of carbon black on the antioxidant.

After repeated researches, it is found that, based on the optimization of specific surface area and oil absorption number of carbon black, the thermo-oxidative aging resistance of polypropylene composition can be effectively improved by adjusting the mole percentage of oxygen on the surface of carbon black. One reason for this may be that carbon black has a negative effect on aging resistance, and another reason may be that the oxygen-containing compounds on the surface of carbon black, especially the carbonyl compounds, are easy to induce the generation of free radicals under the action of light and heat, so that the materials enter a free radical chain reaction, which accelerates the internal consumption of antioxidants and reduces the thermal aging resistance of the materials. By adjusting the mole percentage of oxygen on the surface of carbon black in an appropriate range, the generation of free radicals can be effectively reduced, and then the consumption of antioxidants can be avoided, thereby improving the thermo-oxidative aging resistance of materials. If the mole percentage of oxygen on the surface of carbon black is too high, the antioxidants will have a large consumption, and thus the materials will have a poor thermo-oxidative aging resistance. If the mole percentage of oxygen on the surface of carbon black is too low, the antioxidants may have an accelerated external consumption rate, that is, the antioxidants may have an accelerated migration rate to the surface of the materials, and thus the materials will also have a poor thermo-oxidative aging resistance.

All conventional polypropylene, tougheners and fillers in the field can be used in the present disclosure.

Preferably, the polypropylene has a melt mass flow rate of 1.0 to 150.0 g/10 min under a condition of 2.16 kg load and a temperature of 230° C. in accordance with ASTM D1238-2010.

Preferably, the toughener is one or more of polyolefin elastomer POE, hydrogenated styrene-butadiene block copolymer SEBS, or ethylene-propylene-diene monomer EPDM.

The amount of the toughener can be determined according to the requirements of toughening effect, and preferably the amount of the toughener is 10 to 15 parts by weight.

Preferably, the filler is one or more of a talc powder, calcium carbonate, wollastonite, a whisker or a glass fiber.

The amount of filler can be determined according to the requirements of enhancement effect, and preferably the amount of filler is 5 to 15 parts by weight.

Preferably, the antioxidant is a mixture of a main antioxidant and an auxiliary antioxidant, and a weight ratio of the main antioxidant to the auxiliary antioxidant is (1-3): (3-1).

More preferably, the main antioxidant is a hindered phenolic antioxidant, such as tetrakis [β]-(3,5-di-tert-butyl-4-hydroxyphenyl) propionic acid]pentaerythritol ester (Antioxidant 1010), 1,3,5-trimethyl-2,4,6-tri (3,5-di-tert-butyl-4-hydroxybenzyl)benzene (Antioxidant AO-330), 1,3,5-tris(3,5-di-tert-butyl-4-hydroxybenzyl)-1,3,5-triazine-2,4,6-(1H,3H,5H)trione (Antioxidant 3114).

More preferably, the auxiliary antioxidant is a phosphite antioxidant, such as tri (2,4-di-tert-butylphenyl)phosphite (Antioxidant 168), bis(2,6-di-tert-butyl-4-methylphenyl) pentaerythritol diphosphate (Antioxidant PEP-36), bis(3,5-di-tert-butylphenyl) pentaerythritol diphosphite (Antioxidant 627).

Preferably, the other additive is a lubricant.

More preferably, the lubricant is one or more of calcium stearate, zinc stearate, erucic amide, or oleic amide.

The amount of other additive or additives can be adjusted according to the requirements of corresponding properties, and preferably the amount of other additive or additives is 0.1 to 0.3 parts by weight.

Preferably, the carbon black has a specific surface area of 65-107 m²/g, and an oil absorption number of 98-160 ml/100 g.

Preferably, the carbon black has a molar percentage of oxygen on the surface of the carbon black of 1.74% to 3.45%.

The present disclosure also provides a preparation method of the polypropylene composition resistant to thermo-oxidative aging, which comprises the following steps:

mixing polypropylene, a toughener, a filler, carbon black, an antioxidant and other additive or additives; melting and performing an extrusion process and a granulation process to obtain the polypropylene composition resistant to thermo-oxidative aging.

Preferably, the preparation method of the polypropylene composition resistant to thermo-oxidative aging comprises the following steps:

mixing polypropylene, the toughener, the filler, carbon black, the antioxidant and other additive or additives in a high-speed mixer for 1 to 3 min at a speed of 1000-2000 revolutions per minute (RPM) to obtain a premix; then adding the premix to a twin-screw extruder to melt and perform an extrusion process and a vacuum granulation process to obtain the polypropylene composition resistant to thermo-oxidative aging; wherein the twin-screw extruder has a temperature of 160-230° C. in each region of the screws.

Use of the polypropylene composition resistant to thermo-oxidative aging in manufacturing automotive parts (such as automotive engine parts) or cables (such as black cables) is also within the protection scope of the present disclosure.

Compared with the prior art, the present disclosure has the following beneficial effects:

The polypropylene composition resistant to thermo-oxidative aging provided in the present disclosure has a better thermo-oxidative aging resistance by adding specific carbon black, without any complicated surface modification for the carbon black, and the polypropylene composition can be widely used in automotive parts or cables.

### DETAILED DESCRIPTION OF ILLUSTRATED EXAMPLES

The present disclosure is further elaborated in conjunction with examples below. These examples are provided only to illustrate the present disclosure and not to limit the scope of the present disclosure. Experimental methods where specific conditions are not specified in the following examples are usually performed in accordance with the conditions usual in this field or as recommended by the manufacturer; the raw materials and reagents used, unless otherwise specified, are those can be obtained from conventional markets and other commercial channels. Any immaterial changes and substitutions made by a person skilled in the art based on the present disclosure fall within the protection scope of the present disclosure.

Some of the reagents used in each Example and Comparative Example of the present disclosure are illustrated as follows:
Polypropylene 1: BX3900, SK Inc., Korea, with a melt mass flow rate of 60 g/10 min (ASTM D1238-2010, 2.16 kg, 230° C., the same below);
Polypropylene 2: MH7900, LG Chem LTD., Korea, with a melt mass flow rate of 150 g/10 min;
Polypropylene 3: BX3920, SK Inc., Korea, with a melt mass flow rate of 90 g/10 min;
Polypropylene 4: BX3800, SK Inc., Korea, with a melt mass flow rate of 30 g/10 min;
Polypropylene 5: EPS30R, Dushanzi petrochemical Company, with a melt mass flow rate of 1.0 g/10 min;
Toughener 1: Polyolefin elastomer POE, Engage8842, Dow Chemistry Company;
Toughener 2: SEBS G1657, Kraton Corporation;
Filler 1: talc powder, commercially available;
Filler 2: calcium carbonate, commercially available;
Carbon black 1: Denka Black Granule, Denka Company Limited, Japan, with a specific surface area of 65 m²/g, an oil absorption number of 160 ml/100 g, and a molar percentage of oxygen on the surface of carbon black of 1.74%.
Carbon black 2: Raven 510 Ultra, BIRLA Company, with a specific surface area of 38 m²/g, an oil absorption number of 90 ml/100 g, and a molar percentage of oxygen on the surface of carbon black of 2.41%;
Carbon black 3: Raven PFEB, BIRLA Company, with a specific surface area of 107 m²/g, an oil absorption number of 98 ml/100 g, and a molar percentage of oxygen on the surface of carbon black of 3.45%;
Carbon black 4: Raven 1250, BIRLA Company, with a specific surface area of 113 m²/g, an oil absorption number of 55 ml/100 g, and a molar percentage of oxygen on the carbon black surface of 3.82%;
Carbon black 5: 600 L, Cabot Company, with a specific surface area of 240 m²/g, an oil absorption number of 68 ml/100 g, and a molar percentage of oxygen on the surface of carbon black of 4.20%;
Carbon black 6: Conductex 7055 Ultra, BIRLA Company, with a specific surface area of 55 m²/g, an oil absorption number of 170 ml/100 g, and a molar percentage of oxygen on the surface of carbon black of 3.60%;
Carbon black 7: Raven 1185 Ultra1, BIRLA Company, with a specific surface area of 100 m²/g, an oil absorption number of 100 ml/100 g, and a molar percentage of oxygen on the surface of carbon black of 4.50%;
Carbon black 8: Raven 2350 Ultra, BIRLA company, with a specific surface area of 195 m²/g, an oil absorption number of 62 ml/100 g, and a molar percentage of oxygen on the surface of carbon black of 0.70%;
Antioxidant 1: composed of Main antioxidant 1 and Auxiliary antioxidant 1 in a weight ratio of 1:1;
Antioxidant 2: composed of Main antioxidant 1 and Auxiliary antioxidant 1 in a weight ratio of 2:3;
Antioxidant 3: composed of Main antioxidant 1 and Auxiliary antioxidant 1 in a weight ratio of 3:1;
Antioxidant 4: composed of Main antioxidant 2 and Auxiliary antioxidant 2 in a weight ratio of 1:2;
Main antioxidant 1: Antioxidant 1010, commercially available;
Main antioxidant 2: Antioxidant AO-330, commercially available;
Auxiliary antioxidant 1: Antioxidant 168, commercially available;
Auxiliary antioxidant 2: Antioxidant PEP-36, commercially available;
Lubricant: calcium stearate, commercially available.

The polypropylene compositions of the Examples and Comparative Examples of the present disclosure were prepared by the following process:
(1) each component was weighed according to the parts by weight, then added to a high-speed mixer and mixed for 2 minutes at a speed of 2000 RPM to obtain a premix;
(2) the premix was melted and extruded by using a twin screw extruder, the temperatures in each region of the screws were 160° C., 190° C., 210° C., 210° C., 230° C., 230° C., 230° C., 230° C., 230° C., 230° C., 230° C., and 230° C., respectively, and then the polypropylene composition was obtained by a vacuum granulation process.

The polypropylene compositions obtained in the Examples and Comparative Examples were made into 100 mm*100 mm*2 mm samples by an injection molding process, and their performances were tested. The performance test was performed as follows: A sample was placed in an air ventilation thermo-oxidative aging chamber, with a set temperature of 150° C. and an air exchange frequency of 10 times/hour. The surface condition of the sample was observed every 24 hours. When any phenomenon of discoloration, bubbles, powder and cracking, which could be observed by the naked eyes, appeared on the surface of the sample, the aging time ended. The thermo-oxidative aging resistance of the materials was evaluated by recording the ending of the aging time. The longer the aging time, the better the thermo-oxidative aging resistance of the material.

### EXAMPLES 1-15

A series of polypropylene compositions resistant to thermo-oxidative aging were provided in these examples, and the parts of each component by weight in the formulas and performance test results were shown in Tables 1 and 2.

TABLE 1
Formulas (parts) and performance test results of Examples 1-8.

| | Example | Example | Example | Example | Example | Example | Example | Example |
|---|---|---|---|---|---|---|---|---|
| | 1 | 2 | 3 | 4 | 5 | 6 | 7 | 8 |
| Polypropylene 1 | 70 | 70 | 70 | 70 | / | / | / | / |
| Polypropylene 2 | / | / | / | / | 70 | / | / | / |
| Polypropylene 3 | / | / | / | / | / | 70 | / | / |
| Polypropylene 4 | / | / | / | / | / | / | 70 | / |
| Polypropylene 5 | / | / | / | / | / | / | / | 70 |
| Toughener 1 | 10 | 10 | 10 | 10 | 10 | 10 | 10 | 10 |
| Filler 1 | 16 | 16 | 16 | 16 | 16 | 16 | 16 | 16 |
| Carbon black 1 | 0.3 | / | / | / | 0.3 | 0.3 | 0.3 | 0.3 |
| Carbon black 2 | / | 0.3 | / | / | / | / | / | / |
| Carbon black3 | / | / | 0.3 | / | / | / | / | / |
| Carbon black4 | / | / | / | 0.3 | / | / | / | / |
| Antioxidant 1 | 0.4 | 0.4 | 0.4 | 0.4 | 0.4 | 0.4 | 0.4 | 0.4 |
| Lubricant | 0.2 | 0.2 | 0.2 | 0.2 | 0.2 | 0.2 | 0.2 | 0.2 |
| Aging time (hour) | 1248 | 1176 | 1200 | 1080 | 1296 | 1248 | 1056 | 1272 |

TABLE 2
Formulas (parts) and performance test results of Examples 9-15

| | Example | Example | Example | Example | Example | Example | Example |
|---|---|---|---|---|---|---|---|
| | 9 | 10 | 11 | 12 | 13 | 14 | 15 |
| Polypropylene 1 | 70 | 70 | 70 | 70 | 70 | 40 | 98 |
| Toughener 1 | / | 10 | 10 | 10 | / | 25 | 0 |
| Toughener 2 | 10 | / | / | / | 10 | / | / |
| Filler 1 | 16 | / | 16 | 16 | 16 | 0 | 30 |
| Filler 2 | / | 16 | / | / | / | / | / |
| Carbon black 1 | 0.3 | 0.3 | 0.3 | 0.3 | 0.3 | 0.2 | 2.0 |
| Antioxidant 1 | 0.4 | 0.4 | / | / | / | 0.3 | 0.6 |
| Antioxidant 2 | / | / | 0.4 | / | / | / | / |
| Antioxidant 3 | / | / | / | 0.4 | / | / | / |
| Antioxidant 4 | / | / | / | / | 0.4 | / | / |
| Lubricant | 0.2 | 0.2 | 0.2 | 0.2 | 0.2 | 0.5 | 0 |
| Aging time (hour) | 1152 | 1224 | 1080 | 1272 | 1008 | 1032 | 984 |

### Comparative Examples 1-4

A series of polypropylene compositions were provided in these comparative examples, and the parts of each component by weight in the formulas and performance test results were shown in Table 3.

TABLE 3
Formulas (parts) and performance test
results of Comparative Examples 1-4

| | Compara- | Compara- | Compara- | Compara- |
|---|---|---|---|---|
| | tive | tive | tive | tive |
| | Example 1 | Example 2 | Example 3 | Example 4 |
| Polypropylene 1 | 70 | 70 | 70 | 70 |
| Toughener 1 | 10 | 10 | 10 | 10 |
| Filler 1 | 16 | 16 | 16 | 16 |
| Carbon black 1 | / | / | / | / |
| Carbon black 5 | 0.3 | / | / | / |
| Carbon black 6 | / | 0.3 | / | / |
| Carbon black 7 | | / | 0.3 | / |
| Carbon black 8 | / | / | | 0.3 |
| Antioxidant 1 | 0.4 | 0.4 | 0.4 | 0.4 |
| Lubricant | 0.2 | 0.2 | 0.2 | 0.2 |
| Aging time (hour) | 432 | 528 | 456 | 504 |

It can be seen from the above test results that the polypropylene composition resistant to thermo-oxidative aging provided in Examples 1 to 15 have a better thermo-oxidative aging resistance, and the aging time is more than 900 hours, wherein the compositions in Examples 5 and 12 have the best performances. As for polypropylene compositions provided in Comparative Examples 1 to 4, the thermo-oxidative aging resistances thereof are not efficiently improved since at least one of specific surface area, oil absorption number or mole percentage of oxygen on the surface of carbon black are not regulated properly.

Those skilled in the art will be aware that the embodiments herein are intended to assist the readers in understanding the principles of the present disclosure, and it should be understood that the protection scope of the present disclosure is not limited to such special descriptions and embodiments. Those skilled in the art may make various other specific deformations and combinations according to these technical inspirations disclosed by the present disclosure without departing from the essence of the present disclosure, and these deformations and combinations are still within the protection scope of the present disclosure.

1. A polypropylene composition resistant to thermo-oxidative aging, comprising following components by weight:

| | | |
|---|---|---|
| polypropylene | 40-98 | parts, |
| a toughener | 0-25 | parts, |
| a filler | 0-30 | parts, |
| carbon black | 0.2-2.0 | parts, |
| an antioxidant | 0.3-0.6 | parts, |
| other additive or additives | 0-0.5 | parts, |

wherein the carbon black has a specific surface area of 38-113 m²/g, an oil absorption number of 55-165 ml/100 g, and a molar percentage of oxygen on a surface of the carbon black of 1.70-3.82%.

2. The polypropylene composition resistant to thermo-oxidative aging according to claim 1, wherein the polypropylene has a melt mass flow rate of 1.0-150.0 g/10 min under a condition of 2.16 kg load and a temperature of 230° C. in accordance with ASTM D1238-2010.

3. The polypropylene composition resistant to thermo-oxidative aging according to claim 1, wherein the toughener is one or more of polyolefin elastomer POE, hydrogenated styrene-butadiene block copolymer SEBS or ethylene-propylene-diene monomer EPDM.

4. The polypropylene composition resistant to thermo-oxidative aging according to claim 1, wherein the filler is one or more of a talc powder, calcium carbonate, wollastonite, a whisker or a glass fiber.

5. The polypropylene composition resistant to thermo-oxidative aging according to claim 1, wherein the antioxidant is a mixture of a main antioxidant and an auxiliary antioxidant, and a weight ratio of the main antioxidant to the auxiliary antioxidant in the mixture is (1-3): (3-1).

6. The polypropylene composition resistant to thermo-oxidative aging according to claim 1, wherein the other additive is a lubricant.

7. The polypropylene composition resistant to thermo-oxidative aging according to claim 1, wherein the carbon black has a specific surface area of 65-107 m²/g, and an oil absorption number of 98-160 ml/100 g.

8. The polypropylene composition resistant to thermo-oxidative aging according to claim 1, wherein the carbon black has a molar percentage of oxygen on the surface of the carbon black is 1.74-3.45%.

9. A preparation method of the polypropylene composition resistant to thermo-oxidative aging according to claim 1, comprising following steps:
mixing polypropylene, the toughener, the filler, carbon black, the antioxidant and other additive or additives; melting and performing an extrusion process and a granulation process to obtain the polypropylene composition resistant to thermo-oxidative aging.

10. A method for in manufacturing automotive parts or cables, comprising a step of applying the polypropylene composition resistant to thermo-oxidative aging according to claim 1.

11. The preparation method according to claim 9, wherein the polypropylene has a melt mass flow rate of 1.0-150.0 g/10 min under a condition of 2.16 kg load and a temperature of 230° C. in accordance with ASTM D1238-2010.

12. The preparation method according to claim 9, wherein the toughener is one or more of polyolefin elastomer POE, hydrogenated styrene-butadiene block copolymer SEBS or ethylene-propylene-diene monomer EPDM.

13. The preparation method according to claim 9, wherein the filler is one or more of a talc powder, calcium carbonate, wollastonite, a whisker or a glass fiber.

14. The preparation method according to claim 9, wherein the antioxidant is a mixture of a main antioxidant and an auxiliary antioxidant, and a weight ratio of the main antioxidant to the auxiliary antioxidant in the mixture is (1-3): (3-1).

15. The preparation method according to claim 9, wherein the other additive is a lubricant.

16. The preparation method according to claim 9, wherein the carbon black has a specific surface area of 65-107 m²/g, and an oil absorption number of 98-160 ml/100 g.

17. The preparation method according to claim 9, wherein the carbon black has a molar percentage of oxygen on the surface of the carbon black is 1.74-3.45%.

18. The method according to claim 10, wherein the polypropylene has a melt mass flow rate of 1.0-150.0 g/10 min under a condition of 2.16 kg load and a temperature of 230° C. in accordance with ASTM D1238-2010.

19. The method according to claim 10, wherein the toughener is one or more of polyolefin elastomer POE, hydrogenated styrene-butadiene block copolymer SEBS or ethylene-propylene-diene monomer EPDM.

20. The method according to claim 10, wherein the filler is one or more of a talc powder, calcium carbonate, wollastonite, a whisker or a glass fiber.
